(19) United States
(12) Patent Application Publication
(10) Pub. No.: US 2025/0002236 A1
(43) Pub. Date: Jan. 2, 2025

(54) PAPER BAG AND CONTENTS

(71) Applicant: BAUMIT BETEILIGUBGEN GMBH, Waldegg (AT)

(72) Inventors: Peter WEISSMANN, Waldegg (AT); Thomas BAUER, Guntramsdorf (AT); Uwe GROSS, Neunkirchen (AT)

(21) Appl. No.: 18/292,186

(22) PCT Filed: Jan. 18, 2023
(86) PCT No.: PCT/AT2023/060011

§ 371 Date: Mar. 21, 2024

(30) Foreign Application Priority Data
Mar. 18, 2022 (AT) A50180/2022

(51) Int. Cl. B65D 65/46; C04B 22/14; C04B 28/04; C04B 40/00

(52) U.S. Cl. CPC B65D 65/46; C04B 22/14; C04B 28/04; C04B 40/0042; B65D 2565/382

(57) ABSTRACT

The invention relates to a paper bag having bag contents to be mixed with water. e.g. having a building material such as dry mortar, cement, gypsum, lime and refractory compounds, wherein it is already known that the paper bag contains a disintegration agent so that the bag disintegrates when the bag contents and water are mixed together, and the paper bag does not have to be disposed of separately. A disadvantage of this is that these bags are not very stable mechanically and in terms of storage. According to the invention, the bag contents comprise the disintegration agent for the paper bag, meaning that the bag loses its stability only when its contents comes into contact with water and thus the disintegration agent becomes effective. The disintegration agent or one of the disintegration agents is preferably a wetting agent, a dispersing agent, a surfactant, a flow agent, a disintegration aid (debonding agent) for paper disintegration into paper pulps, or a base. The at least one disintegration agent can also be a substance combination, wherein one part of the substance combination is contained in the material of the paper bag (bag paper or bag adhesive) and the other part of the substance combination is contained in the bag contents.

### TECHNICAL FIELD

The invention relates to a paper bag with dry dust-like, pulverulent or granular contents for mixing with water, where the water dissolves the paper bag when its contents and the paper bag are mixed together. The bag contents are in particular a binder (cement, refractory cement, gypsum, lime, etc.) or contain a binder (such as dry mortar and refractory materials). However, the bag contents can also be a filler or generally an arbitrary pulverulent or granular substance, for example an additive, a chemical or an additive agent or an additive material.

### PRIOR ART

For the filling, palletizing, storage, transport and handling (before and during the processing) of powder- or dust-like, partially granular materials such as dry mortar predominantly paper bags made of kraft paper are currently used to meet the high requirements during the entire process chain (filling, transport, storage, handling by the processor before and during processing) for such products.

Primarily, materials and media such as building materials (dry mortar or binders such as cement, gypsum, lime, etc.) are used in such paper bags, but also masses (for example refractory materials), fillers or various similar dry, pulverulent or granular substances such as chemicals, additives, additives and supplements are filled, stored, transported and washed. Paper bags of this type must be suitable for materials of considerable weight, i.e. must have a high tensile or tensile strength and mechanical stability. What is known as a cardboard paper is for example a suitable bag wall material for this purpose. Such bags typically have one, two or more layers (laminated “walls” of paper material or combinations of paper material with polymeric layers or coatings), in order to make and protect the bag structure against external mechanical forces, but also against environmental influences such as humidity, steam, wetness, microorganisms, etc. Cardboard with high porosity is frequently used as the bag material in order to ensure venting of the bag during filling, but this venting can also be achieved by certain design features of the bag, for example vents in the bag valve or a perforation of the paper etc. can be provided.

Traditionally, processing the above-mentioned building materials, masses, binders, fillers, chemicals, additives, and supplements entail mechanically opening (cutting open) the bags filled with the different materials, tearing, etc.) and the bag is then separated from the contents and the material content is mixed with water (or another liquid medium) (for example in a tilt-drum mixer or free-fall mixer, manual stirrer/quirl mixer or forced mixer) that mixes the different materials more or less rapidly and intensively mixed with a wet mortar, a pasty/liquid mass or a “dough” or a suspension, color, etc. with the purpose of further processing the materials (whether as a finished product for the respective application or as a semi-finished product for further processing steps). This results in large amounts of used empty packaging materials contaminated with residues of the bag contents that in turn have to be handled, manipulated and fed to a subsequent process (disposal, recycling, etc.).

Furthermore, plastic bags made of polymers such as for example polypropylene are also used for these materials and media to be mixed and these have advantages (storage capacity, tightness, etc.) but also large disadvantages, since these polymers are currently produced largely from fossil (petroleum-based) hydrocarbons and thereby have a negative ecological impact (CO₂, sustainability, ecological footprint) and also are not cost-effective comparted to paper bags.

Bags made of disintegratable paper materials (for example D-sack from Billerud Korsnaes) have been available on the market for a relatively long time, these bags disintegrating when mixed with water. During the mixing process, the paper of the bags disintegrates with the product into its individual constituents, i.e. the “bonded” cellulose fibers are separated more or less during the mixing process. It is no longer possible to detect optically as bag residues and thus become part of the mixed product.

As a rule, bleached white paper is used for this purpose, since it is better in terms of dissolution behavior and above all over time or storage duration and the disintegration behavior is more stable than brown paper bags that include residual lignin.

EP 2,963,178 describes the production of such bleached kraft papers that are distinguished above all by a high porosity and are suitable for the production of disintegratable bags for the cement and building-material trades. Bags made of kraft paper must withstand high loads. These loads occur during filling, storage under heavy loads and during transport. The load-bearing capacity of paper is influenced to a large extent by its weight per unit area. In order that adequate performance can be achieved during the filling of the bags, a corresponding venting of the bag or paper must be provided. The venting can take place in part by a special bag construction, but above all through the paper wall, and therefore sufficient bag-paper porosity is necessary. This can be controlled by paper production or obtained by subsequent perforation of the paper. In order to be able to achieve the water-soluble properties of the paper, corresponding steps must be taken into account in the production of pulp. Furthermore, in the production of such paper, the amount and type of binder included in the added must be limited. In addition, the paper must have a certain water absorption capacity in order to be able to disintegrate at all. The bag made of the described paper is used for the packaging of cement or gravel and together with the bag and Additional water is fed to a concrete mixer.

EP 3,044,369 describes the preparation and composition of an unbleached (brown), water-soluble bag paper and the production of a paper bag from this paper entails the production and composition of an unbleached (brown), water-soluble bag paper. In this context, reference is made to the special requirements of kraft papers. Lignin-containing paper, as in brown paper, is difficult to dissolve in water because of the hydrophobic properties of the lignin. In order to counteract this problem, surfactants are added to the paper mixture during the paper production in order to reduce the surface tension of the paper and to permit rapid penetration of the water. The aim is that this paper dissolves or disintegrates into fibers due to the low wet strength under the action of water within a few minutes. In order to achieve satisfactory disintegration of the bag, reference is made to the use of a maltodextrin adhesive as an adhesive. A possible coating of the papers with water-soluble polyvinyl alcohol or polyether is also contemplated, in order to achieve a barrier effect. The strength of the paper can be increased by using a dry solid. The use of unsized papers (no sizing of the paper mixture) is also contemplated.

EP 2,399,836 discloses the production of bags that dissolve in water and speaks of the adhesive used in this case describes a significant role. In this case, these bags are predominantly used as cement bags and processed into concrete with sand and water in a mixer. It is indicated that conventional water-soluble adhesives do not lead to an acceptable dissolution result. Such disintegration of the bag, even in the case of moist consistencies of the concrete, can only be achieved by the use of dextrin adhesives. Glued paper packets in the valve and bottom area are described as being critical with regard to their resolution. Therefore, it should be possible completely to dispense with paper packets or to apply at least the overlapping of the individual paper layers to one as small a surface as possible. By means of a special folding of the bag in the valve region, glue can also be saved. Furthermore, reference is made to the use of readily water-soluble paper (undissolved and with small proportions of starch) and water-soluble ink for the bag imprint. In order to achieve satisfactory dissolution of the bag, the concrete may also include a coarse gravel fraction. According to this patent, such bags could also be used as packaging for fibers that are added to a concrete.

EP 2,963,179 describes a paper bag that can be disintegrated with water and that, together with its contents, such as for example cement, can be loaded into a mixer and then breaks down in the mixer to such an extent that the disintegrated bag does not significantly influence the mixing process and the product. Accordingly, it would not be necessary to open such a bag and to mix its contents separately from the bag, that the product can be mixed together with the bag and the bag is thus part of the mixed product. According to this document, a precoating of the bag with inorganic filler not only facilitates the disintegration, but also the amount of expensive barrier chemicals required to obtain an effective moisture barrier is also reduced. It is speculated that the surface provided by the precoating ensures film formation and barrier functionality of the bag surface and nevertheless enables good disintegration of the entire bag.

In addition, some alternative solutions for bags that consist of water-soluble or disintegrated bag materials have also been proposed:

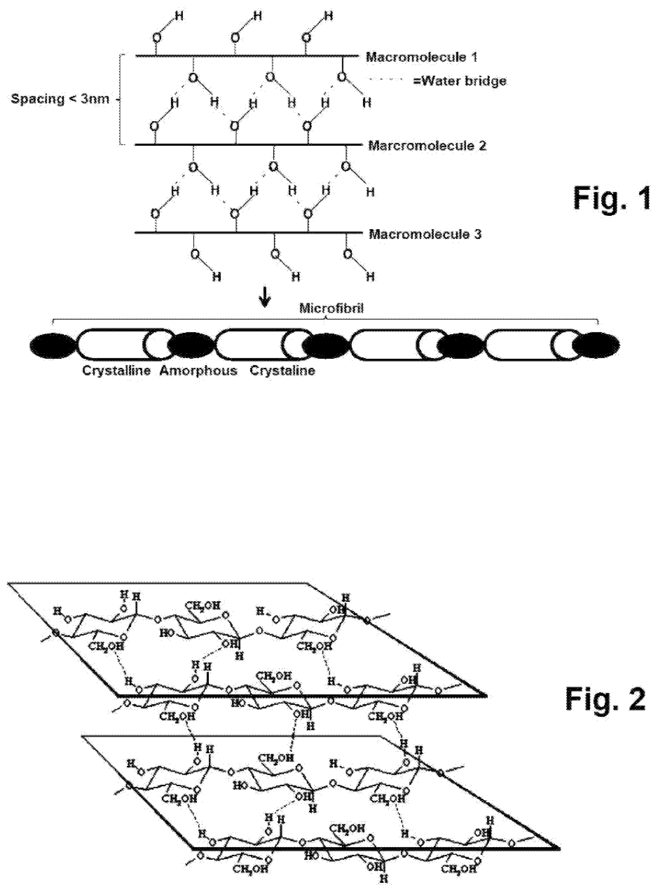

WO 2004/052746 shows in FIG. 1 a bag with a water-soluble inner layer and a waterproof outer layer. The waterproof outer layer can be produced for example by spraying or dipping the bag. It is also recommended to break up the bag and place it in a mixer containing a certain amount of water so that penetration of water into the bag causes the water-soluble inner layer of the bag to dissolve, as a result of which the water-tight exterior of the bag can decompose.

FR 2,874,598 proposes that a cement bag be subjected directly to water in a mixer and consists of a water-soluble material such as polyvinyl alcohol. JP H0585565 discloses a similar solution.

Furthermore, it is known that additives for better disintegration (so-called “debonding agents”) can be integrated into paper or cellulose slurries during the paper-making process, in order to ensure more rapid fragmentation or disintegration of the paper fibers during subsequent contact with water. This is for example shown in of U.S. Pat. No. 6,159,335. The “sheet” produced is an initial product for the production of diapers, sanitary napkins and the like, i.e. should have as low a strength as possible from the outset and is thus completely unsuitable as packaging material.

The above-described bags from the cited patent literature have not yet been found on the market in a large scale because they weaken during the dissolving or dissolution process. Their disintegration behavior after mixing with commercially available mixers is affected large bag residues generally remain in the wet fresh mortar. In addition, there are problems with the storage stability of such bags, above all with respect to moisture, such as for example rain that only makes them suitable for use on construction sites to a limited extent. In order to achieve good resolution with respect to disintegration, it is currently necessary to use as thin-walled, water-soluble paper bags with a low basis weight. Since such paper bags are also more sensitive to moisture exposure during storage and handling, this represents a disadvantage with respect to conventional kraft paper bags.

Furthermore, it has been found to be technologically disadvantageous for disintegrating bags with conventional commercially available mixers themselves with optimum product and bag combinations (coarse product with high shear action, average plastic product consistency, long mixing times >5 min), use of single-layer, barrier-free or coating-free bag paper qualities with low grammages below 100 g/m², obtaining complete wetting of the bag surface with water, etc.) is not successful in mixing the materials in such a way that no residual bag pieces remain after the mixing process (even if these are often not visible in the first case). In particular, bag parts from the valve or bottom structure are to be evaluated as problematic with regard to disintegration or technical resolution, since a plurality of paper layers are located one above the other at these points for reinforcing the bag, and “paper packets” are adhesively bonded to one another in part by the inserted bag adhesives.

### DETAILED DESCRIPTION OF THE INVENTION

The object of the present invention is to match bag and bag contents to one another in such a way that the bag has both good resistance in storage and handling and good solubility or disintegration during mixing with water. Furthermore, the bag paper used is to disintegrate as completely as possible and the finished mixed end product, in which the disintegrated bag is dissolved, is not or only insignificantly negatively affected by the bag fibers that are now present in a separate manner that are part of the mixed product are influenced.

This is achieved according to the invention in that the bag contents has at least one disintegration agent for the paper bag.

The idea on which the invention is based is not providing the disintegration agent as described in above-mentioned U.S. Pat. No. 6,159,335 in the paper, but in the bag contents, so that the paper retains its original strength until it interacts with the disintegration agent as a result of the action of water on the bag contents. The bag contents are thus produced by targeted modification to the active and functional component of the mixing method with disintegratable bags, in that at least one bag ingredient in the mixing process leads to a significantly better disintegration of the bag paper. This means that certain disintegration agents in the bag contents in the dry state have no effect during storage and behave in a neutral manner and are activated only during the mixing process by water, and actively then participate in the “opening process” of the bag (packaging paper or of the bag adhesive) and thus decouple the disintegration of the bag from the pure paper or bag properties. Thus, according to the invention, the properties of a bag that is to dissolve during mixing can be controlled in a targeted manner both during storage and during disintegration.

As a result, completely new possibilities for the novel safety disintegration technology and the above-mentioned disadvantages or problems can be solved. In addition, the influence of the type and the time of the addition of water is reduced and critical bag areas (valve and bottom area) are of less criticality.

Furthermore, it is possible to shorten mixing times in order to reduce the mixing energy, to decouple the mixing result of shear forces resulting from the mixing consistency and the grain size distribution (coarse grain ratio: fine grain), and to reduce dependency on mixers specifically designed for this technology.

Since the solubility in the mixing process is now controlled via substances from the bag contents protected by the bag paper during dry storage, less moisture-sensitive, more robust disintegratable bag paper can be used, paper having a higher basis weight and thus higher tear strength or also multiple layers and possibly also coated papers/bags can also be used. Thus, the previous disadvantage of the necessary low basis weight of resolving bags can be compensated for.

It is preferred that the disintegration agent or one of the disintegration agents be a wetting agent, a dispersant, a surfactant, or a flow agent. The disintegration of the bag is significantly improved by the use of wetting agents, dispersants, surfactants or flow agents.

Alternatively or also, it can be provided that the disintegration agent or one of the disintegration agents is a base. As a result of the generation of OH ions, the pH can rise to for example above 10. This results in incipient alkaline degradation reactions on the cellulose (alkaline-oxidative degradation from the reducing end of the cellulose chains, denaturation of glycoside compounds). Disintegration of the bag can thus be further improved.

It is particularly advantageous if the at least one disintegration agent is a multicomponent substance and one component of this substance is in the material of the paper bag (bag paper or bag adhesive) and the other component of the multicomponent substance is in the bag's contents. In their synergistic interaction during mixing, the substances of the multicomponent substance bring about better and faster dissolution properties of the disintegrated bag. The part that is contained in the packaging material (the bag) can be contained in the bag paper, in the used bag adhesive or both.

Such bicomponent or multicomponent systems make it possible for the bag paper (or the bag adhesive) to disintegrate only upon contact and reaction of the component from the bag contents in the aqueous mixing phase.

Furthermore, it is advantageous if at least one drying agent is also provided in the bag content. This causes free moisture in the packaged material to be absorbed and thereby better protects the water-soluble bag paper against moisture (for example in the case of prolonged storage) and thus imparts significantly more safety with respect to storage stability. Despite the action of ambient humidity that is unavoidable, the moisture acting from the outside does not mechanically weaken the disintegratable bag during storage of the bag because the disintegration agent in the bag contents reacts prematurely with the paper.

### Way (e) to Carry Out the Invention

In order to understand the disintegration behavior of the bag, one must first understand the construction of the material/paper from which the bag consists and the interaction with the ingredient, the mixer and water.

### Paper, Paper Chemistry, Paper Disintegration

Paper fibers consist predominantly of cellulose. The cellulose, β-D-(1-4)-glucan, is a homopolysaccharide that is composed of 1-4 glucosidically linked anhydro-D-glucose units. Cellulose is the most common organic substance occurring on the surface of the earth and is present in all plant material. It is important to mention here that various plants and plant parts contain different proportions of cellulose. This biomolecule is unbranched and can consist of up to tens of thousands (β-1,4-glycosidically linked) β-D-glucose or cellobiose units. Since these cellobiose molecules have a strong association tendency, they easily join one another to form hydrogen bridges and thus form cellulose chains.

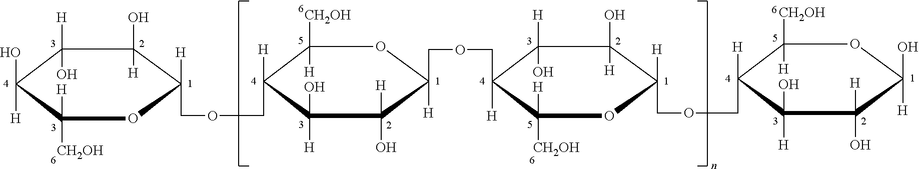

Linking these high molecular weight cellulose chains creates a thread-shaped macromolecule with a reducing end (aldehyde group in half acetal form on carbon atom 1) and a non-reducing end (secondary hydroxyl group formed by carbon atom 4). All glucose units are present in the “dish shape” so that the following conformational scheme arises.

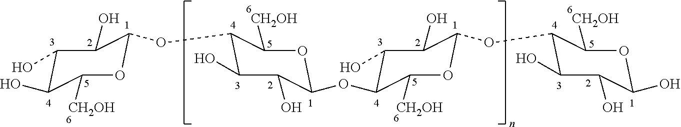

Due to the regulated linear structure and the dipole character of the hydroxy groups (OH), intra- and intermolecular hydrogen bonds form. The result is a higher molecular structure of ordered (crystalline) and less ordered (para-crystalline) regions, as shown in FIG. 1.

In FIG. 1, the macromolecules 1, 2 and 3 represent the cellulose molecules as a line. The respective free hydroxy groups of the macromolecule 1-cellulose molecules form with the free hydroxy groups of the macromolecule 2-cellulose molecules Hydrogen bond. The same can be seen between macromolecule 2 and macromolecule 3.

The formation of inter- and intramolecularly active hydrogen bridges is seen that join together to form a three-dimensional microfibril (see FIG. 2).

In the case of wood, the proportion of the crystalline cellulose in the total cellulose is 50-70% (usually about 70%). This structural feature is important for the swelling and reaction properties of the cellulose. The reaction or swelling of the native cellulose with strong alkali solutions creates from the native cellulose the so-called hydrocellulose that, despite the same chemical structure, has an expanded lattice in the crystalline regions. As a result, a significantly more rapid absorption of water, wetting agents or dispersing agents is possible.

The typical wood and pine wood for cellulose consists of about 48-59% of cellulose fibers, the predominant residues are hemicellulose and lignin, as well as to a small extent also resins and other accompanying substances (extract substances, fillers). Hemicelluloses are macromolecular carbohydrates and constituent of the cement substance in the fiber wall and between the fibers.

Compared to cellulose, the degree of polymerization of hemicellulose is substantially lower and the macromolecules usually have a branched structure. Lignin is a 3-dimensional macromolecular aromatic compound that also builds up the plant from glucose. Lignin connects the fibers, gives the wood its strength. It leads to yellowing of the products in papers, has water-repellent properties and hinders the swelling of the fiber wall.

The major chemical constituents of wood have a substantial influence on the technological processes in the manufacture of fibrous material and paper, as well as the paper properties. In the case of high-quality bag papers, only the cellulose or natural fiber is relevant because hemicelluloses and lignin are almost completely dissolved and eliminated in the cooking process. For high-quality bag papers, softwood sulfate pulps are predominantly used. In Europe, fish and pine wood are preferred.

The desired bag paper specification, inter alia defined by the basis weight in g/m², strength, longitudinal and transverse, stretch-to-break, burst strength, wet strength, tear propagation, color, thickness, moisture, sizing, etc. can be controlled very well with or without feedback by a complex production-engineering automation system in the paper production process.

### Paper Production

During paper production on the bag-paper machine, additives are generally supplied to the fibrous material in a targeted manner in order to influence various properties of the paper: for example glue is added for hydrophobing (mass hydrophobization or surface application for improving the resistance of the paper to wetting, penetration and absorption of liquids) and to improve wet strength starch, CMC, natural and synthetic polymers, defoamers, retention agents, pigments, etc are added. All of these substances remain in the paper after the production process and in this way become a functional component of the paper. They therefore also influence the wettability or disintegration of paper directly or indirectly.

### Disintegration of Paper

Waste paper or newly produced paper in the form of edge sections, residues on rolls, loose bag paper, paper layers and rejects are currently used in special fabric dissolvers, so-called pulpers, for the purpose of reuse in the papermaking process Disintegrated. With addition of circulating water at 30-50° C. the mixture is preferably stirred intensively at 5 to 6% material density and the paper structure is broken down into individual fibers by shear forces. In this case, the specific energy use can be up to 100 kWh/t.

The so-called MC technique has proven successful for highly sized, wet-resistant or extremely solid grades. As a rule, 12 to 18% of dry solids concentration is used here, the high frictional forces are introduced into cylindrical vessels by special screw rotors. After disintegration of these papers, a final material treatment is generally carried out by stripping and/or grinding.

Further additives to improve disintegration are generally limited to alkalis in the paper industry, and special papers are used for better and faster wetting and disintegration of chemicals in the paper processing process. Such additives are for example chemicals based on tall oil, for example Buckman Busperse 59LO, disodium peroxodisulfate, for example Buckman BRD 2358, or polyalkylene glycol ethers, for example Solenis Nopcosperse ENA 2154.

### Bag Contents

This is primarily so-called dry mortar (building materials), these are dry premixed multicomponent systems that are generally composed of additives, sand, fillers, binders and additives and supplements.

The additives, sands and fillers usually consist of limestone, dolomite or quartz, the binders of Portland cement, gypsum, lime, fly ash, metallurgical sand, pozzolans or special binders (such as for example aluminous melt cement or sulfoaluminate cement), further additives can be a wide variety of chemical and/or mineralogical composition and are classified according to active compound groups.

The most important are: redispersible powders (adhesion-reinforcing to ground, elastifying, crack-reducing, . . . ), water-retention agents, hydrophobing agents, accelerators, retarders, flow agents, thickeners, defoamers, air-entraining agents, stabilizers, fibers, open-time extenders, pigments, shrinkage reducers, dust binders, sealants and odor agents.

Dry mortar can have a wide variety of compositions and thus properties by combining these formulation constituents. The fineness (particle size distribution) of the added additives, sands and fillers also plays a large role for the property profile of such building materials. For example, dry mortar can be present very fine (as a filler having the largest grain size of 0.1 mm) or very coarse (e.g. as dry concrete with maximum grain 10 mm), i.e. in a wide variety of variants, mesh sizes and compositions.

Masses are for example ceramic or refractory materials, these are in principle constructed similarly to dry mortar, but only consist predominantly of refractory aggregates and fillers such as magnesia (MgO), corundum (Al₂O₃), chamotte, etc. as well as temperature-resistant binders such as for example alumina melt cement with high Al²O³ contents, etc. and additives that are not dissimilar to those in dry mortars.

Binders or fillers are the pure substances (Portland cement, . . . ) mentioned in dry mortars or mixtures thereof.

Chemicals or additives in dry or pulverulent or granular form as pure substances or mixtures are concentrates of active substances that are used in a wide variety of processes (chemical industry, concrete industry, building material industry, ceramic or refractory industry, textile industry, plastics industry, metal industry, paper industry, petroleum industry, etc.).

### Mixer

With regard to commercially available mixers for the above-mentioned materials, it must be mentioned that there is a large number of different mixing methods and mixer types. On the one hand, there are mixers and mixing tools that are actuated manually, and on the other hand there are semi- and fully automatic mixers. Furthermore, continuous mixers and (discontinuous) batch mixers are used.

The following mixers apply at the present time as the most important types for the hitherto conventional mixing of bag material in building materials, masses, binders and additives:
Manual agitators (“mixing quirons”)
Tilt drum mixer (“free fall mixer”)
Compulsory mixer (“concrete mixer,” “egg mixer”)
Continuous-flow mixers (consisting of a dry-conveying zone and a wet-conveying zone)
Mixing pumps (combination of automatic mixing and conveying as a rule with screw pumps)
Mixing rakes (very simple tools for manual mixing of for example mortars with a handle and a simple attachment, for example in the form of a rake for purely manual mixing)

### Mixing of Materials in Disintegrator Bags

In order to better understand the disintegration behavior, the process of disintegration of the all-in bag (brand name for products in the disintegrated, dissolvable bag of the building group) is described. Dry concrete in the all-in-bag is processed to form a fresh concrete with the addition of water. In this case, the product together with the packaging bag is stirred with water, unpacking and emptying, i.e. the separation of mortar product and bag container before the mixing process can thus be dispensed with. The all-in bag is a bag package of disintegratable special paper with a very high proportion of cellulose that loses strength very quickly by absorption of water in combination with the mechanical energy input during mixing and thereby disintegrates very rapidly.

The product can usually be mixed with a hand stirrer (mixing quirl), tilting drum mixer (free fall mixer), positive mixers or other suitable mixing devices (manual, simple mixing tools). In principle, discontinuous mixing processes are better suited for this technology than continuous mixing processes. What is important here is that the addition of water takes place before the mixing starts or simultaneously with the start of the mixing process. The longer the product together with the packaging is in direct contact with the mixed water, the more time the packaging, water is to be absorbed, “softens” and loses strength. As a result, the paper structure is weakened, and the packaging can be comminuted together with the bag ingredient or filling material with mechanical force expenditure in the mixed product and disintegrate into individual fibers.

Note: Without taking up water (i.e. in the dry state), the paper is significantly more resistant and can only be torn with high force or energy expenditure.

In order to hydrate the product from all sides with a sufficient amount of water, it is recommended to use a mixing vessel into which the bag can be inserted or placed intact. In the first working step, care should be taken to ensure that a large part of the bag is wetted with water. The bottom and the valve area are also well covered with water since these regions have to be regarded as critical with respect to their resolution or disintegration on account of the construction (multiple paper layers above one another), these regions have to be considered to be critical. The subsequent, complete over-casting or soaking, or Wetting of the bag with the remaining required water is also certainly to be carried out.

In order to mechanically tear the moistened paper of the bag mechanically and to allow further water access to the drying material, the mixing tool must be driven by suitable mixers by mechanical chopping and tearing energy (by edges, corners, prongs, strips etc.) acting on the bag. These mixing elements “strike” at the beginning of the paper and destroy the bag wall.

Mixing devices in which the material in the mixer must be transported in the dry state before the addition of water do not meet this specification (an example of this would be a conventional continuous mixer-customary use, for example in the building material industry) and are therefore not suitable for this technology.

It should be mentioned here that currently in Europe for such concretes in the conventional mixing process (the prior separation of the bag bundle from the material is common before starting the mixing process), primarily in the DIY range, predominantly manual stirring mechanisms (mixing quire, drilling machine mixer) or tilt drum mixer.

The disintegration behavior of the paper in the mortar or the mixing result of the medium, including bag (bag disintegration should take place as completely as possible, bag residual pieces should ideally no longer be present after completion of the mixing process, as these inhomogeneities could adversely affect the product quality and cause technical or optical defects) in this case as a function of several factors:
Bag quality (basic dissolution behavior of the disintegrated bag paper)
Bag paper with or without barrier coating
Paper thickness or surface-density (Grammage g/m²) One or more layers of the bag
Bag construction in the valve or bottom area
Type of Blind glue used
Amount of the bag glue used
Formulation of the material to be mixed (ratio of coarse and fine fractions is important for acting shear forces)
Type of Addition of Water
Consistency of the Mixed Material
Mixing time
Mixer type (mixing intensity) and mixing tools
Ambient temperature

### Disintegration Agent

Extensive testing and testing with a wide variety of formulations and formulation constituents of contents or filling material show that very specific additives are obtained from the bag contents (e.g. dry mortar) in solid or pulverulent, granular or even in small amounts of liquid form (these are small proportions of liquids that have the appearance, the shape or the consistency of the dry mortar does not change), the result is that the mixing result is significantly improved by including, when the bag contents are mixed the paper bag, the bag disintegration process proceeds significantly faster and more efficiently and significantly smaller or no bag pieces remain after the mixing process.

These additives can also be in the form of liquid components that are applied to a solid carrier medium and can thereby be mixed dry in the mortar, or as a liquid component in an encapsulated form, so that these capsules can be introduced into the dry mortar as a “solid component.” The following additives or additive groups have been found to be particularly effective:

### a) Wetting and Dispersing Agent/Surfactants/Flow Agents

These are additives that permit very rapid wetting of the solid components of the bag ingredient by lowering the surface tension of the liquid medium (mostly water) or filling material, but also of the cellulose fibers of the self-dissolving bag.

The use of nonionic, anionic, cationic and amphoteric surfactants from the bag ingredient accelerates the dispersion of the cellulose fibers.

Furthermore, by adding association colloids consisting of amphiphilic molecules such as surface-active substances, the disintegration can be significantly accelerated into the bag ingredient. Due to self-assembly, the amphiphilic molecules bind to one another to micelles and destroy the homogeneous cellulose unit.

Additives of these active compounds have compositions based on ethylene oxide/propylene oxide-copolymers, polyglycol esters, polyalkylene glycol ethers, glycol derivatives such as for example ethylene glycol, propylene glycol; modified polysiloxanes, polycarboxylate ethers (PETs), melamine sulfonates, naphthalene sulfonates, lignin sulfonates, alkali lauryl sulfates (e.g. Na-lauryl sulfate), alkoxylated polymers, polyoxyethane (propyl) diols, acetylene diols, alkyl sulfonates, alkylbenzenesulfonates, ethanediyl-propylheptylene, alkali-oleophilic, synthetic polyelectrolytes, Preparations of polycarboxylic acids and of phosphonates, highly polymeric polysaccharides, polyalkyl sulfonates or other compounds known to the person skilled in the art for this purpose.

Mixtures of surfactants based on fatty alcohols (e.g. fatty alcohol polyethylene glycol ether, methyl ester sulfonates, fatty alcohol sulfates, etc.), fatty acid amide alkyl betaines, sodium polynaphthylmethane sulfonates, sulfonated and ethoxylated fatty alcohols and fatty acids, phosphoric acid esters and resin soaps.

Furthermore, this also includes the use of various surfactants that are already used in the paper industry and are used for denaturation and solubilization of macromolecules such as cellulose or cellobiose. Cetyl trimethylammonium bromide, polysorbate 20 or salts of bile acids can be used for this purpose.
Use range of—up to: 0.001-0.5%
Preferably: 0.001-0.2%
Particular preference is given to: 0.001-0.1%

### b.) Disintegration Agents

These are additives that are already used by the paper industry for paper disintegration as process aids (debonding agents) for paper disintegration in so-called pulpers. Additives in this group of active ingredients are for example the oxidizing or bleaching-agent persulphates and have compositions based on for example disodium peroxodisulphate (e.g. trade name Buckman BRD 2358), potassium peroxomonosulphate (e.g. trade names Caroat or Oxone). The following active substances can also be used: Bases of ammonium complexes: e.g. [Cu(NH₃)⁴]²⁺, bases of amine complexes e.g. [Cu(en)²]²⁺ (en=ethylenediamine, H₂N—CH₂—CH₂—NH₂), quaternary ammonium bases [NR]⁺, (R=e.g. alkyl), iron-sodium tartrate complexes or iron-tartaric acid-sodium complexes. These active ingredients have the property of dissolving cellulose or intensifying disintegration.

Furthermore, by adding the quaternary ammonium salt, triethyloctyl ammonium chloride to the bag ingredient or filling material, the polarity of the water can be significantly increased and thus the solubility potential can be accelerated. The hydrogen bonds of the cellulose are effectively attacked by this additive, and the biopolymer (cellulose) can even be dissolved or even dissolved in ideal conditions. This results in a significantly accelerated disintegration process of the bag paper.
Use range of—up to: 0.001-0.5%
Preferably: 0.002-0.2%
Particularly preferred: 0.005-0.1%

### c) Combination-Synergistic Additives

This is understood to mean additives or additive combinations that, in their synergistic interaction, bring about a significantly faster and more efficient disintegration of the paper bag. At least one additive active ingredient can be added to the packaging ingredient or filling material and at least one to the bag paper (during production of bag paper) or to the bag adhesive (during bag production). Only when mixing with water is the at least one active substance from the packaging content or filling material in solution and passes via the aqueous phase to the reaction partner in the bag paper or bag adhesive. This reaction process results in a significantly accelerated disintegration process of the paper bag. That is, the bag paper or the bag adhesive is modified in a targeted manner by one or more active substances and the activation of the disintegration process is started by reacting this active compound or these active compounds with at least one active substance from the filling material. The starting reaction is triggered by the mixing process.

This can be carried out according to the invention as follows: Additives are added to the substance of the bag contents or filling material, the additives being esterified with the cellulose of the disintegrated bag etherification reactions (starting from the surface) and, as a result, significantly accelerate the disintegration capability.

The following cellulose modifications are possible in detail:

### Esterification Reactions:

Nitration: Production of nitrocellulose (cellulose nitrate) by reacting cellulose with nitric acid, sulfuric acid, water.

### Etherification Reactions:

Alkyl ethers, for example to methyl cellulose, are produced by reacting cellulose with alkyl chloride in the alkaline medium: Cellulose-OH+Cl-CH₃→Cellular-O-CH₃+HCl
Hydroxyalkyl ethers, for example to hydroxyethyl cellulose: Cellulose-OH+Cl-CH₂—CH₂—OH→Cellulose-O—CH₂—CH₂-OH+HCl
By reacting cellulose with chloroacetic acid, carboxymethylcellulose is obtained: Cellulose-OH+Cl-CH₂—COO—Na→Cellulose-O—CH₂—COO-Na⁺+HCl

In addition to rapid disintegration, this can also result in the formation of new active compound functionalities (for example increasing the water retention capacity in the mixed material).

### Complexing Agent Reactions:

A further example of the combinatorial synergetic mode of operation are complexing agents that are incorporated into the bag paper (but also in the surface thereof) or the bag adhesive and then with for example Ca²⁺ ions from that react when mixed with, the bag ingredient or filling material to form a chelate complex. These can significantly accelerate the cellulose fiber denaturation or fiber separation (disintegration). Examples of such complexing agents are: ethylenediaminetetraacetic acid (EDTA), methylglycinediacetic acid (MGDA), hydroxyethyl ethylenediamine triacetic acid (HEEDTA) or modified anionic polyamine.
Field of Application*of—up to: 0.02-5%
Preferably: 0.05-4%
Particularly preferred: 0.1-3%
Use range applies to the respective individual components in the bag contents material or paper bag or bag adhesive

### d) Drying Agent

These are reactive substances that extract moisture or water from the environment by chemical bonding or adsorption and have compositions based on: Cao, MgO, CaCl₂), phosphorus pentoxide, sodium sulfate, magnesium sulfate, calcium sulfate, sodium carbonate, potassium carbonate (drying by chemical H₂O bond), zeolites, bentonites, silica gel (drying by adsorption).
Field of Application of—up to: 0.1-10%
Preferably: 0.3-7%
Particularly preferred: 0.5-5%

### e) Highly Alkaline Bases (Alkalis)

These are active compounds or additives that produce high concentrations of OH ions in aqueous solutions, as a result of which the pH usually rises to >10. This results in incipient alkaline degradation reactions of the cellulose (alkaline-oxidative from the reducing end of the cellulose chains, denaturation of glycoside compounds). Examples that may be mentioned here are NaOH, KOH, Ca(OH)₂, Na₂ CO₃, etc.
Field of Application of—up to: 0.1-10%
Preferably: 0.3-7%
Particularly preferred: 0.5-5%

### Examination Methodology of Resolution Behavior (Disintegration)

The determination methodology aims to evaluate the resolution (disintegration) of bag paper. This does not constitute a standardized method, and other determination methods for evaluating the resolution can also be used. In the determination methodology described below, a practical worst-case scenario is assumed. This means that a paper packet (consisting of 4 layers of water-soluble paper) is first mixed in contact with an already mixed fresh concrete and undergoes water access. In this case, the paper does not experience any preceding direct wetting with water, in other words, the paper must have the moisture necessary for disintegration exclusively from the mortar that has already been mixed.

For this purpose, it is necessary to proceed as follows:
1. 10×10 cm pieces are cut from the bag paper to be examined. In this case, only paper is taken out of the bag wall, and regions with gluing (valve, bottom region and gluing on the rear side of bags) are disposed of.
2. The pieces of paper are to be prepared in packets each of 4 pieces for the experiments.
3. Fresh water at 20° C. is introduced into a mixing vessel (laboratory mortar mixer according to EN 196, suitable for the cement industry).
4. Dry concrete with a maximum grain size of 8 mm is scattered while the mortar mixer is stirred (stage 1=140/min) for 15 s into the trough. This results in a water requirement of 12% (based on the dry mortar).
5. The mixture is then stirred further for 45 seconds (further step 1). After this mixing time, the concrete should already have its processing consistency.
6. The stirring bowl is lowered and a paper packet is placed below the stirrer on the surface of the fresh concrete.
7. Raising the mixing vessel presses the paper packet into the concrete by the fixed stirrer. In this case, the paper package conforms to the stirrer in such a way that there is a layer (outer layer) of paper that is in contact with the concrete and an inner layer that bears directly against the stirrer and thus has no contact with the fresh concrete. This takes place within 10 seconds after stopping the mixing process and lowering the mixing vessel.
8. The stirring process is then started again for 20 seconds (stage 1). During this mixing time, the paper packet absorbs water from the mortar by contact with the fresh concrete, and the shear forces of the grain and the mixer start disintegration of the paper. The mixing time of 20 s simulates a critical case during mixing in practice, namely that, the dry bag paper comes into contact with the mortar only very late in the mixing process on the construction site. Longer mixing times are not applicable, since the informative value in relation to the mode of action of the resolution of the bag paper (by different additives, etc.) in correlation with observations is not given in practice (mixing of whole bags in commercially available mixers).
9. After the mixing process, the concrete-paper mixture is examined for remaining paper pieces.
10. The paper pieces are examined with respect to size, strength, wetting of the individual layers and the number of layers present. In this case, it is expedient to mark the individual layers before the test in order to be able to distinguish the inner (no direct contact with the concrete) or external (direct contact with concrete) paper layers from one another.
11. Following the evaluation of the pieces of paper found, the concrete is examined for relevant fresh mortar parameters in order to determine the influence of the added additive into a standard dry concrete mixture. Here, the fresh mortar weight, air pores and the consistency represent important parameters.
12. If the amount of paper pieces found is to be examined gravimetrically, the exact weight of the 4-ply paper packet must be determined before mixing. Thereafter, after the fresh mortar test, the mortar-paper mixture can be carefully washed by one or more sieves. A multistage washing process is required to separate the entire mortar material from the paper. The screens must be selected in such a way that the paper pieces of the relevant size can be collected, but a separation from the surrounding mortar material (e.g. up to 8 mm large grain sizes) can take place. After rinsing, the paper/water mixture is dried in a drying cabinet to constant weight and the dry paper mass is then weighed. The redried paper is then placed in proportion to the mass of the paper packet prior to the experiment. This results in a further parameter of the dissolution behavior of bag paper. During the washing process, care must be taken to ensure that there is no post-comminution of the paper pieces, there is otherwise the danger that the paper pieces do not need to be comminuted as a result of the enormous excess of water and with excessive mechanical stress due to the water jet, they significantly lose strength and are prone to disintegration or disintegration.

### Embodiments

For purposes of illustration, the invention and advantages underlying the patent are intended to be presented on the basis of embodiments.

A simple recipe for standard dry concrete (without optimization for disintegrator packages) is used as the reference material (starting base):
15% binder (Portland cement CEM I 52.5 R)
85% sand/gravel (lime sand mixture of different grain fractions (0.01-8 mm), largest grain 8 mm)
   a) Recipe of a dry concrete optimized for use in disintegratable self-dissolving paper bag packages by addition based on sodium lauryl sulfate (wetting and dispersing agent):

The reference material is added:
0.0025% sodium lauryl sulfate (wetting agent and dispersant)
   b) Recipe of a dry concrete optimized for use in disintegratable self-dissolving paper bag packages by addition based on potassium peroxodisulfate (disintegration aid from the paper industry):

The reference material is added:
0.05% potassium peroxodisulfate (disintegration aid)

As a reference, a dry concrete is mixed as described above. To this end, 2500 g of dry concrete and 300 g of water (corresponding to a water requirement of 12%) are mixed. After the end of the mixing time of 1 min, the concrete has a consistency between 15 and 16 cm of spread according to 15 strokes on the spreading table according to the method of Haermann. The paper packets of 4 layers of bag paper is now inserted into this mortar. After the next 20 s mixing duration (stage 1), the dissolution of the paper is assessed.

In this reference concrete, the result can be described as follows:

The paper packet can be seen well in the mortar. The individual layers of the paper packet are clearly identified and do not adhere to one another, since large areas of the paper pieces are still dry and no water could absorb from the mortar. The outer paper layer facing the mortar is moistened most intensively and even at some points is rubbed through the material to be mixed, or there are no cracks or corners of the paper. Thus, there is hardly any comminution/defibration of the paper. From the second layer, large dry areas can be found. The paper layers have a high tear strength except for the outermost layer (facing the concrete). The inner layers are neither completely moistened nor attacked/comminuted by the mortar. The fresh mortar parameters show the values customary for a concrete, the fresh mortar weight is in the range between 2250 and 2300 kg/^{M3}. The air pore content is in the range between 2 and 4%.

In comparison to the reference concrete, the result of reference concretes modified with additives according to examples a) and b) is now described. Both additives bring about very similar disintegration results that are hardly to be distinguished, and a double description is therefore dispensed with.

The mixing operation proceeds according to the same scheme as described in the above example. The only difference lies in the composition of the dry concrete that corresponds to those from example a) or b).

After the mixing process, the result can be described as follows:

A large paper packet is apparently not visible in the mortar. It is only during the manual search of the mortar mixture that residual paper pieces can be scanned. The original paper packet has divided into substantially smaller pieces. The paper pieces are to be found in part in sizes of 5×5 cm, 1×1 cm or less. In all cases, a plurality of layers of paper adhere to one another, and at least two and at most four layers of paper can be seen. The paper packets are well moistened and the individual layers are difficult to separate from one another. The individual paper layers can be torn apart with little effort. The paper structure is already clearly and significantly weakened. The water absorption of the paper from the mortar functions satisfactorily. The paper was not yet completely defibrated in the short mixing time of 20 seconds, However, a significant and significant improvement over the reference concrete (without additives) can be seen.

The fresh mortar test shows that, as a result of the use of the additive, some test parameters deviate somewhat from the standard concrete. The fresh mortar weight is now in a range between 2200 and 2270 kg/^{M3}, and the air pore content is between 3 and 6%. An entry of a certain amount of air into the concrete is not to be excluded in an additive-specific manner and must be evaluated case to case. The values measured here, however, lie in an acceptable frame and can also be measured in the case of concretes without corresponding additives. The consistency of the concretes (example a) and b)) corresponds to that of the reference dry concrete.

In summary, it can be determined that through the use of these two additives, the water absorption from the fresh concrete into the bag paper could be substantially accelerated, as a result of which the bag paper has a significantly faster and measurable better disintegration. The water transport is also accelerated between the individual paper layers by the additives.

Thus, the specific additions according to the invention ensures a better/faster dissolution of single-layer or multilayer disintegrated paper bags in a practical mixing method (tilting drum mixer, Quirl mixers, compulsory mixers, etc.) with disintegrator “real bags” are closed.

c) Recipe of a dry concrete optimized for use in disintegratable self-resolving bags from Example a) in combination with a combinatorial-synergistic complexing agent system for an also improved resolution of the Blind adhesive:
The following procedure is carried out as follows for detecting the better resolution of glued paper packets by addition of the bag adhesive with a synergistically combinable complexing agent:

In this case, instead of the previously described multilayer paper packet (consisting of four individual layers), as in the previously described determination method, a glued paper packet consisting of six layers is used. The paper packet must be laminated together with the glue mixture to be examined before the test procedure. The quantity of the glue applied must be comparable in all experiments and is specified at approximately 80 g/m². After the six layers of paper (10×10 cm² together), the packet is pressed in order to obtain a defined layer composite. The packet is then dried for several hours at 40° C. in a drying cabinet and then stored conditioned at 20° C./65% RH until the test procedure is carried out.

For the experiments, a reference concrete is used as in example a) from a dry concrete and an addition of 0.0025% Na lauryl sulfate. This ensures that the individual layers of the paper packet are rapidly moistened and that a reaction between the glue and the concrete can take place.

The experimental procedure is otherwise identical to the experiments described above. Identical devices are used. The amount of concrete and water used (2500 g of dry concrete and 300 g of water) and the mixing duration are likewise identical to the dissolution tests described above, the mixing time for producing the concrete requires 1 minute and the paper packet is mixed in for 20 seconds. The paper packet is positioned centrally below the agitator as before, so that, after the mixing vessel has been raised, there is an outer side facing the concrete and an inner side facing away from the concrete.

The result of an experiment with a paper packet produced with the referenced glue, in this case is a cold water-soluble, corn starch-based bag glue (Agrana, Amtropaste P26), can be described as follows:

The paper packet is readily recognizable as such in the dry concrete. The outer layers are well moistened. The outer side facing the concrete was roughened by the mechanical action, and parts of this layer were maintained during mixing the concrete. The paper packet still consists of six layers of paper, but the sixth layer is only partially present. The glue below the outermost layer of paper is fixed and no dissolution of the glue can be seen. The remaining layers of the packet adhere firmly to one another and cannot be separated from one another.

In comparison to this, the result with the use of the reference glue that was previously mixed with 3% of the complexing agent EDTA, can be described as follows (97% dry substance bag glue Agrana amtropaste, 3% dry substance EDTA):

The paper packet is also readily visible in the dry concrete. The individual paper layers are well moistened. The paper of the outer side facing the concrete is attacked, roughened and the glue lying underneath is already tacky. The paper packet consists of four complete layers of paper with additional adhesions of the fifth layer, and the adhesions of this layer can be easily released. The outermost sixth layer has already been distributed in the concrete and comminuted into smaller pieces of paper. The fourth layer (that is predominantly still present) can also be detached from the rest of the paper packet with little effort. It is clearly noticeable that the glue between the individual layers has already been chemically attacked or dissolved and the adhesion force between the layers is significantly reduced.

Since the same concrete formulation was used in both cases described above and the accelerated approach of the blind glue shows no effects on the measured concrete parameters, in both cases it can be concluded therefrom that there are no negative effects on the concrete properties as described in Example a).

The direct comparison between the two glue mixtures shows that a chemical reaction is made possible by the addition of complexing agents to the reference bag glue that leads to faster separation of the paper layers as a result of the rapid weakening of the bonding glue. When a dry concrete bag is mixed in a free-fall mixer or other mixing unit, this leads to a minimization of the required mixing duration and mixing intensity. The required shearing forces, the mixing intensity and the mixing time in order to separate poorly soluble blind spots (from valve or bottom region), are of importance as a result.

1. A combination comprising:
a paper bag; dry dust-like, pulverulent or granular contents for mixing with water and held in the paper bag; and
a disintegration agent mixed with the contents and reactable with water to form a compound that disintegrates the paper bag when the bag contents and the paper bag are jointly mixed with water.

2. The combination according to claim 1, wherein the bag contents is binder, dry mortar, refractory material and filler.

3. The combination according to claim 2, wherein the binder is cement, refractory cement, gypsum or lime.

4. The combination according to claim 1 wherein the disintegration agent is a wetting agent, a dispersant, a surfactant, a flow agent or a disintegration aid for disintegrating the paper into pulp.

5. The combination according to claim 1, wherein the disintegration agent is a base.

6. The combination according to claim 1, wherein the disintegration agent is one component of a multicomponent substance capable of disintegrating the paper bag, the one component of the multicomponent substance being contained in the material of the paper bag and another component of the multicomponent substance is contained in the bag contents.

7. The combination according to claim 1, further comprising:
at least one drying agent in the bag contents.

8. The combination according to claim 1, wherein the disintegration agent is one component of a two-component substance whose other component is in the paper bag.
